(19) United States
(12) Patent Application Publication
(10) Pub. No.: US 2012/0260865 A1
(43) Pub. Date: Oct. 18, 2012

(54) Weather Resistant Configurable Leashes and Collars

(76) Inventor: Catrina R. Nesper, Kailua, HI (US)

(21) Appl. No.: 13/438,796

(22) Filed: Apr. 3, 2012

Related U.S. Application Data
(60) Provisional application No. 61/475,503, filed on Apr. 14, 2011.

(51) Int. Cl. A01K 27/00

(52) U.S. Cl. 119/792; 119/863; 119/858; 119/797

(57) ABSTRACT

The present invention relates to weather resistant lightweight and user configurable leash collar sets. In one embodiment, the leash collar set includes a leash and a collar made primarily from strips constructed by folding two or more layers of a thin and lightweight material. The collar includes a buckle, a triple slide and a double bar attachment, thereby enabling an overall length of the collar to be adjustable. The leash includes a latching attachment and a triple bar slide. The leash strip is threaded through the leash slide and also threaded through the leash slide, thereby forming an adjustable leash strip loop with an adjustable circumference.

### CROSS REFERENCE TO RELATED APPLICATIONS

This non-provisional application claims the priority of Provisional Application Ser. No. 61/475,503 filed on Apr. 14, 2011, of the same title, which application is incorporated herein in its entirety by this reference.

### BACKGROUND

The present invention relates generally to leashes and collars. More particularly, this invention relates to weather resistant, user configurable pet leash and collar sets. Such leash and collar sets can be configured to meet the particular needs of different users, thereby providing convenience and increased flexibility of usage.

Typically, leashes and collars are made from one or more of traditional materials such leather, metal chains, nylon webbing, cotton webbing, polypropylene webbing. All these traditional materials suffer from one or more disadvantages including bulkiness, excessive weight, abrasive edges causing chafing of the neck, dyes running, and premature rotting or other inferior weathering characteristics.

In addition, although external accessory bags do exist for attaching to the leash or collar to store useful items such as pet treats or waste disposal baggies, they add to the bulk of the leash or collar and increase the likelihood of entanglement with other objects during use.

It is therefore apparent that an urgent need exists for weather resistant lightweight and user configurable leash collar sets. These improved leash collar sets will enable users to easily configure the length, flexibility of wear style, and include built-in pocket(s) for storing one or more useful items such as waste disposal baggies.

### SUMMARY

To achieve the foregoing and in accordance with the present invention, a weather resistant, lightweight and user configurable leash collar set is provided.

In one embodiment, the leash collar set includes a leash and a collar made primarily from strips constructed by folding two or more layers of a thin and lightweight material such as recycled spinnaker sail made from fast drying ripstop nylon.

The collar includes a buckle having a first mating section and a corresponding second mating section. The first end of the collar strip is coupled to the first mating section. The collar strip is also looped around a bar of the second mating section, enabling the second mating section to slide along the collar strip.

The collar also includes a triple bar slide and a double bar attachment. The triple bar slide has a first end bar, a middle bar and a second end bar. The middle bar is attached to the second end of the collar strip. The collar strip is threaded between the first end bar and the middle bar of the collar slide and also threaded between the second end bar and the middle bar of the collar slide, thereby enabling an overall length of the collar to be adjustable. The double bar attachment has an outer bar and an inner bar. The collar strip is threaded between the outer bar and the inner bar of the double bar attachment, which can be a double bar D ring.

The leash includes a latching attachment and a triple bar slide. The latching attachment is attached to the first end of the leash strip. The latching attachment is configured to be secured to the double bar attachment of the collar. The triple bar slide has a first end bar, a middle bar and a second end bar. The middle bar is attached to the second end of the leash strip. The leash strip is threaded between the first end bar and the middle bar of the leash slide and also threaded between the second end bar and the middle bar of the leash slide, thereby forming an adjustable leash strip loop with an adjustable circumference.

Ideally, hardware for the leash collar sets are made from a corrosion resistant, strong, weather resistant and lightweight materials such as Polyacetal, nylon, fiberglass, carbon fiber, aluminum, magnesium, and combinations thereof.

In some embodiments, the leash and/or the collar includes one or more built-in pockets which can be used to store useful items such as pet waste baggies, keys, identification, medical supplies and pet treats.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A-1C illustrate a lightweight weather-resistant user-configurable leash collar set, in accordance with one embodiment of the present invention;

FIG. 2 shows hardware components for constructing the leash collar set of FIG. 1A in greater detail;

FIGS. 3A-3C are cross sectional views illustrating the construction of exemplary leash strips and collar strips for the leash collar of FIG. 1A;

FIGS. 4A-4F illustrate different embodiments of built-in pocket designs for the leash collar set of FIG. 1A; and

FIGS. 5A-5B are front and back views, respectively, showing a pet owner using the leash collar set of FIG. 1A configured for sling-carry hands-free mode while running or walking with her dog.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

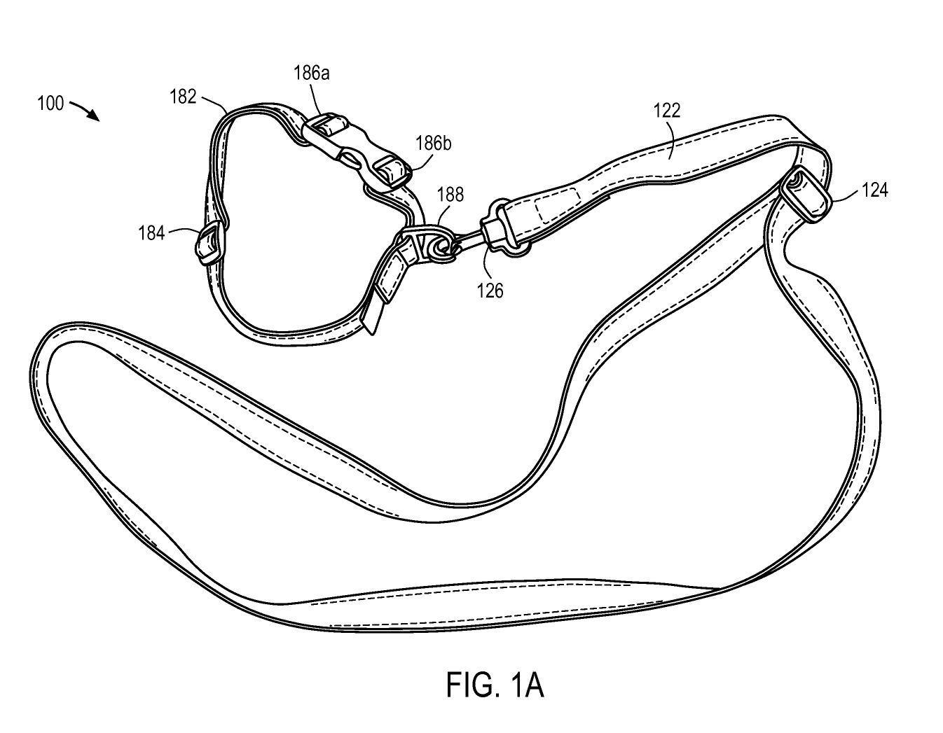

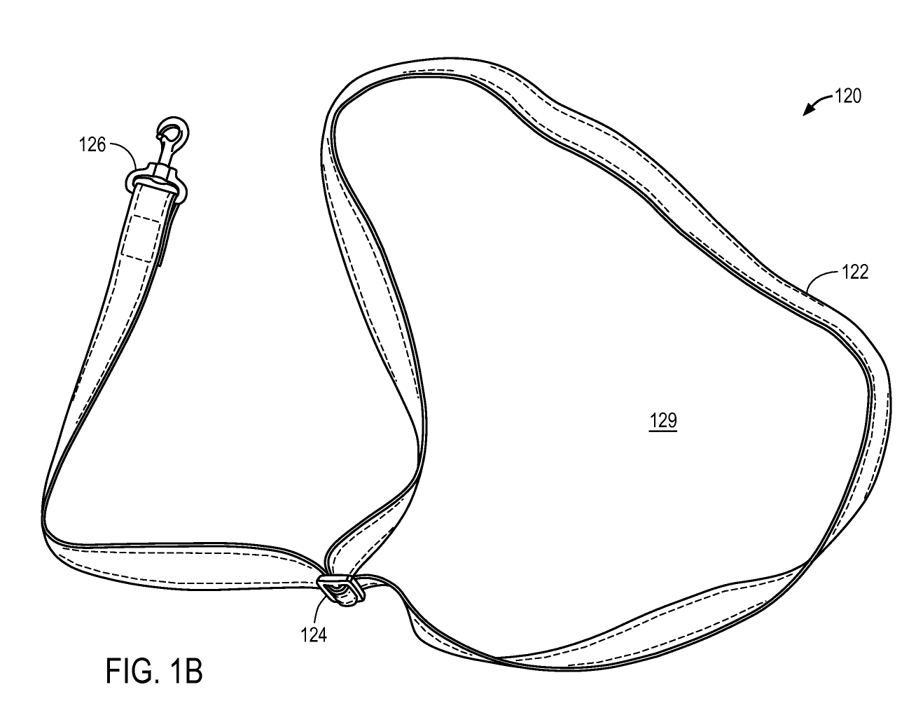

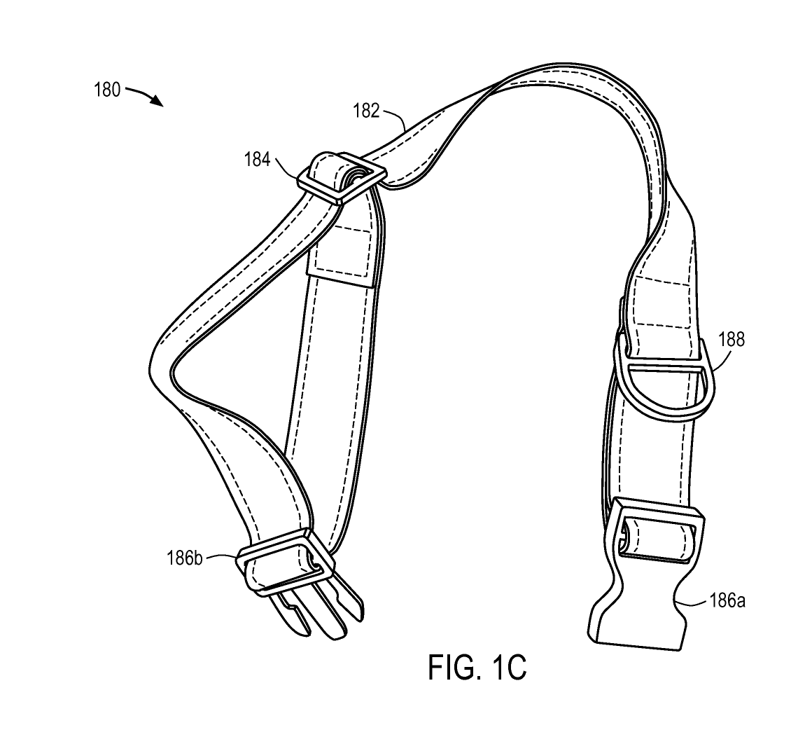

To facilitate discussion, FIGS. 1A-1C illustrate an exemplary embodiment of a weather resistant leash collar set 100, with FIG. 1A showing the set 100 with its components coupled together, while FIG. 1B shows a decoupled leash 120 and FIG. 1C shows a decoupled collar 180 in an opened configuration. Note that leash 120 is sometimes referred to as a lead.

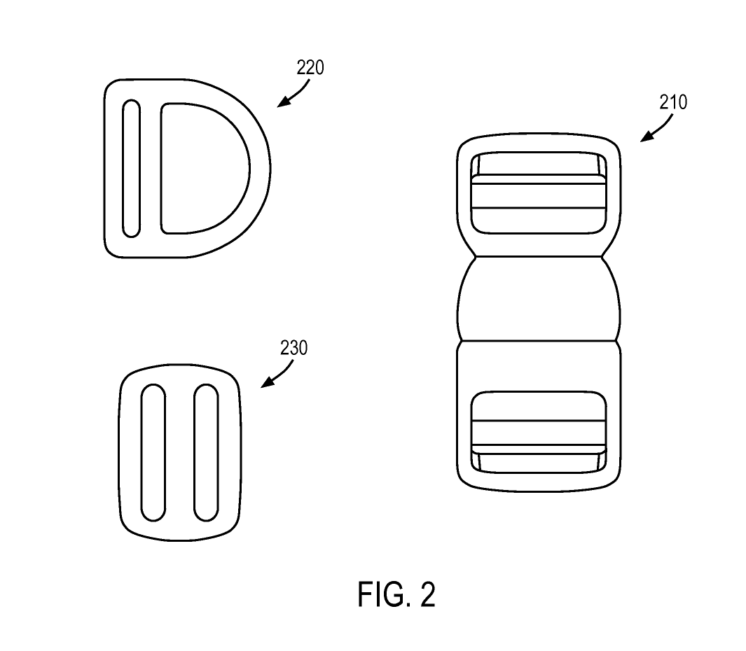

In addition, FIG. 2 shows the various exemplary hardware components useful for constructing leash collar set 100, including a quick release buckle 210, a double bar D-ring 220, and a triple bar slide 230, which can be made from corrosion resistant, tarnish resistant, strong, lightweight and weather resistant materials such as Polyacetal, nylon, fiberglass, carbon fiber, aluminum, magnesium, and combinations thereof.

In this embodiment, the leash 120 includes a leash strip 122, a latching attachment 126, and a triple bar slide 124, as shown in FIG. 1B, and the collar 180 includes a collar strip 182, a buckle with two corresponding mating sections 186a, 186b, a triple bar slide 184, and a double-bar attachment 188 (such as double-bar D-ring 220), as shown in FIG. 1C.

The first end of the collar strip 182 is looped around a bar of buckle mating section 186a, and then stitched to itself, thereby securely coupling section 186a to strip 182. For efficiency and ease of manufacturing, section 186a can be securely coupled to collar strip 182 during the process of securing stitching double bar attachment 188 to collar strip 182.

Note that the double bar attachment 188 provides a stable attachment point for securing leash 120 to collar 180. Enhanced stability of attachment 188 is accomplished by threading the collar strip 182 between the inner and outer bars of the double bar attachment 188, and then stitching collar strip 182 to itself, thereby forming a tube-like structure across strip 182 to fit the outer bar of attachment 188. The double bar and tube-like structural combination of attachment 188 and strip 182, respectively, also eliminates the problem of attachment 188 rotating during use. This combinational feature also prevents collar strip 182 from collapsing, e.g., bunching up and/or folding over itself, thereby maintaining the overall structural integrity, e.g., “flatness”, of an otherwise flexible and very comfortable collar 180.

The second end of the collar strip 182 is looped around a bar of buckle mating section 186b, enabling mating section 186b to slide along the collar strip 182. The collar strip 182 is also threaded between the first end bar and the middle bar of the triple bar slide 184, and threaded again between the second end bar and the middle bar of the slide 184. The second end of the collar strip 182 is attached to the middle bar of triple bar slide 184. This configuration of the collar strip 182 with buckle section 186b and triple bar slide 184 enables the overall length of the collar 180 to be adjusted as needed by the user, to for example fit a substantially wide range of neck circumference sizes.

For additional comfort of, for example a pet dog, buckle mating sections 186a, 186b may have a cambered profile. Further, although in this exemplary embodiment, mating section 186a is female, while mating section 186b is male, the two mating sections 186a and 186b can be interchanged without affecting the functionality of collar 180.

Referring again to FIGS. 1A and 1B which illustrate leash 120, a latching attachment 126, e.g., a swivel hook, is attached the first end of leash strip 122. As discussed above, latching attachment 126 of leash 120 is configured to be secured to double bar attachment 188 of collar 180 to form a complete leash and collar set 100. Note that leash 120 can be used with other suitable training, restraining or controlling devices such as pet harnesses or muzzles (not shown). Conversely, collar 180 may also be compatible with other leash designs (not shown).

To accommodate user preferences for different leash lengths, the leash strip 122 is threaded between the first end bar and the middle bar of the triple bar slide 124, and threaded again between the second end bar and the middle bar of the slide 124. The second end of the leash strip 122 is attached to the middle bar of triple bar slide 124. Such a configuration of the leash strip 122 with triple bar slide 184 enables the overall length of the leash 120 to be easily adjusted as needed by sliding strip 122 through slide 124, depending on the specific application desired by the user.

This configuration of the leash strip 122 and slide 184 also results in the formation of an adjustable leash strip loop 129 with an adjustable circumference, enabling the user to form a handle or to use the leash 120 to secure a pet to an object by for example lassoing loop 129 over a parking meter and then reducing the circumference of loop 129 to snugly and securely fit the support pole of the parking meter without having to decouple the leash 120 from the collar 180.

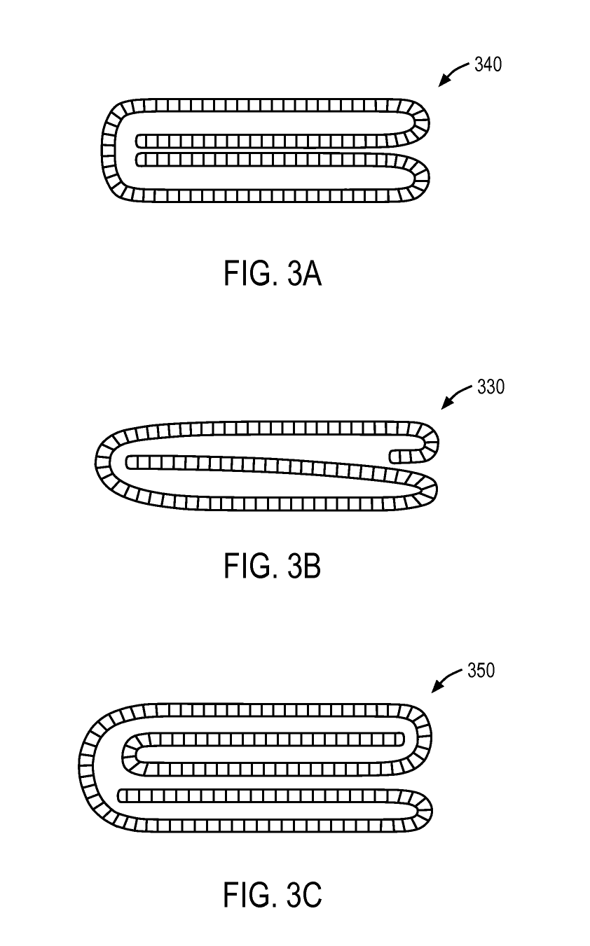

Referring now to the cross-sectional views of FIGS. 3A-3C, a suitable lightweight fast drying material such as recycled spinnaker sail made from fast drying ripstop nylon, is used for constructing the leash strip 122 and the collar strip 182 of weather resistant leash collar set 100. Ripstop nylon suitable for constructing spinnaker sails typically range in weight from approximately 0.5 ounce to 3 ounces. Other suitable lightweight and weather resistant materials known to one skilled in the arts made from synthetic and/or natural materials or blends thereof can also be used for the construction of strips 122 and 182.

In some embodiments, as shown in FIG. 3A, an approximately four-inch wide strip is folded over inwardly to form a four-layer strip 340. This four-layer strip is then stitched along both edges, resulting in a strong weather resistant and lightweight strip 340 approximately one inch wide. Leash 120 and/or collar 180 made from strip 340 substantially optimizes the tradeoff between strength, softness and rigidity, and is capable of comfortably securing an animal without for example chafing the neck of the animal. This fully functional leash and collar set 100 is very lightweight, compact and fits easily in a pant pocket when not in use.

FIGS. 3B and 3C also show additional exemplary strip embodiments, a three-layer strip 330 and a five-layer strip 350, which can be customized to specific needs for lighter or stronger leash and collar sets, respectively. Other layering methods and/or number of layers are also possible within the scope of the present invention.

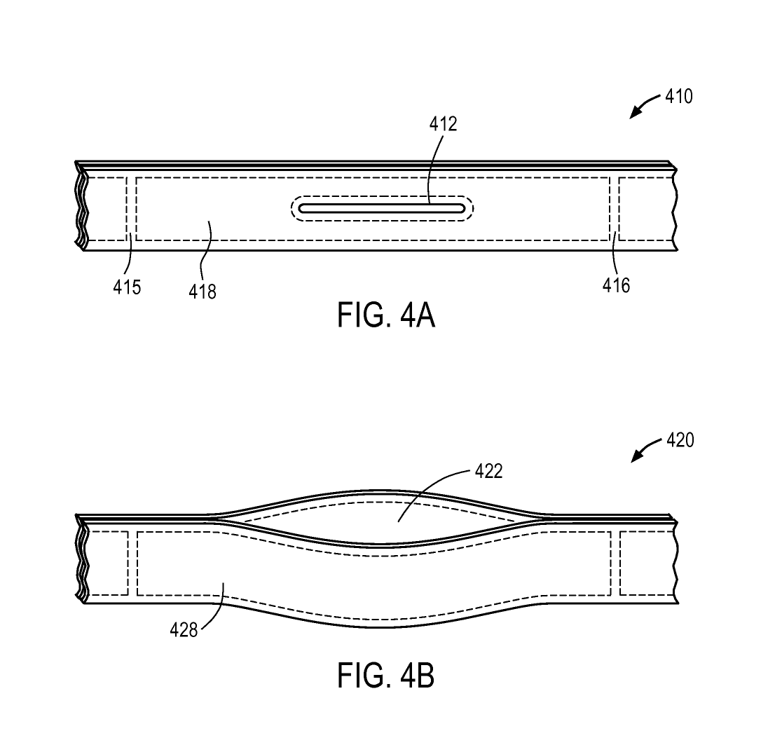

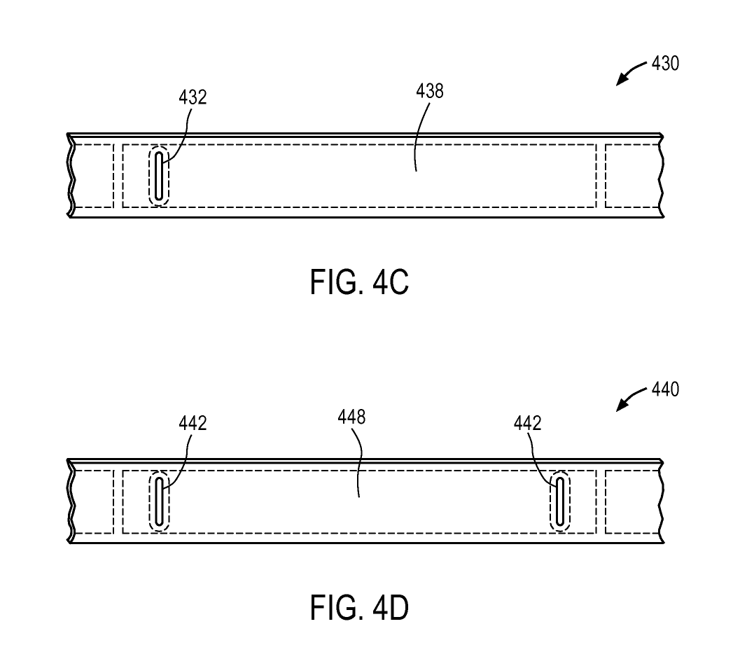

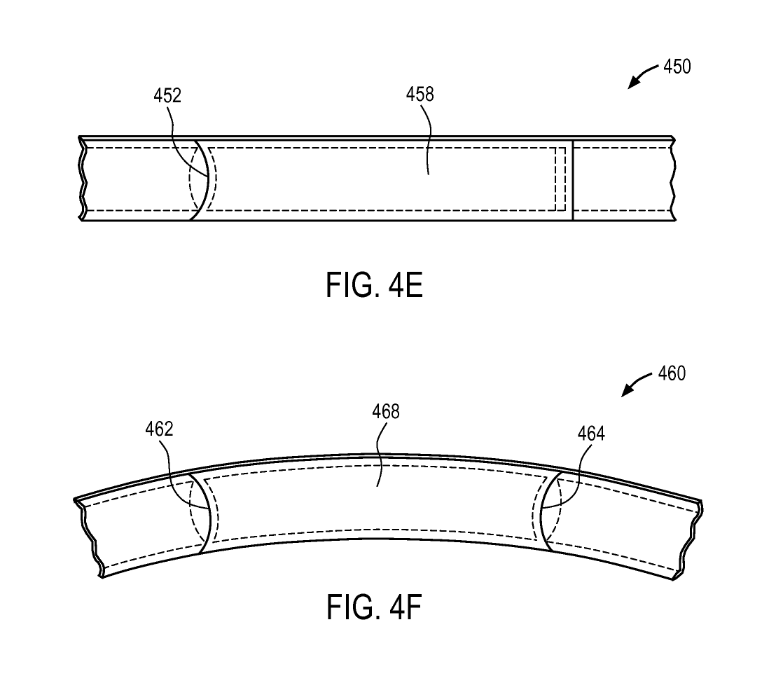

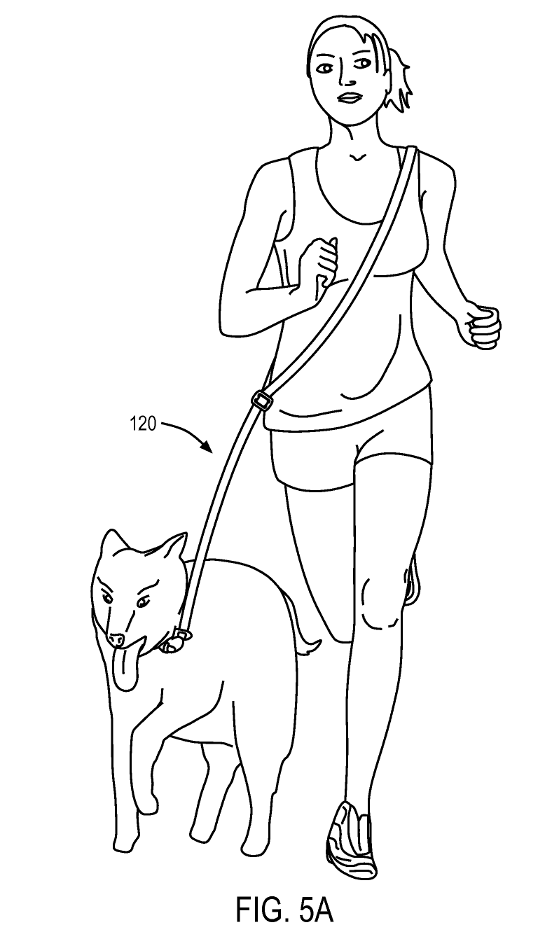

In some embodiments, as illustrated by FIGS. 4A-4F, leash collar set 100 includes at least one build-in pocket for storing one or more useful items. Built-pocket(s) can be located in leash 120 and/or collar 180. Exemplary useful items include but are not limited to pet waste baggies, keys, identification, medical supplies and pet treats.

FIG. 4A shows one embodiment of a partial strip 410 with a built-in pocket 418 formed by stitching at two locations 415, 416 across part of the strip, e.g., part of leash strip 122, thereby closing the ends of the pocket 418. A buttonhole style opening 412 is created by cutting through approximately half the layers of the multi-layer strip, e.g., two layers, and possibly one or three layers, of a four-layer strip. Advantages of this embodiment include no extra strip material needed to create the built-in pocket and also the ability to accommodate hardware components such as sliding the triple bar slide 124 over the pocket 418 when it is empty.

Additional embodiments of partial strips 420, 430, 440 with built-in pockets are illustrated by FIGS. 4B-4D. FIG. 4B shows a wallet style pocket 428. Construction of the pocket 428 is substantially similar to that of pocket 418, except the opening 422 located on one edge of the strip, e.g., leash strip 122. Hence, advantages of this embodiment also include no extra strip material needed and the ability to accommodate hardware components such as the triple bar slide when not in use.

Referring now to the partial strip 430 of FIG. 4C, it is also possible to orientate a buttonhole style opening 432 substantially perpendicular to, i.e., in a direction across, the strip 430. Built-in pocket 438 formed by stitching at two locations across the strip 430 and forming the ends of the pocket 418. The pocket opening 432 is created by cutting through approximately half the layers of the multi-layer strip.

Multiple pocket openings are also possible, as illustrated by FIG. 4D, which shows a partial strip 440 that includes a built-in pocket 448, also constructed by stitching at two locations across the strip 440 to form the ends of the pocket 448. In this embodiment, two buttonhole style openings 442, 444 are provided to enhance ease of access to built-in pocket 448.

Other alternate embodiments of built-in pockets for leash collar set 100 are also possible. FIG. 4E shows yet another embodiment of a partial strip 450 with a shirt pocket style opening 452 located on one end of the built-in pocket 458. Built-in pocket 458 can be constructed by stitching a patch comprising of one or more additional layers of strip material in a manner similar to the construction of a typical shirt pocket.

As discussed above, it is possible to have more than one pocket opening, such as dual openings 462, 464 of built-in pocket 468 as shown in partial strip 460 of FIG. 4F. Advantages of have two openings include the ease of item storage/removal and ease of cleaning. For example, animal waste baggies can be stuffed into pocket 468 by pushing from one opening 462, and then retrieved by pulling from the opposite opening 464.

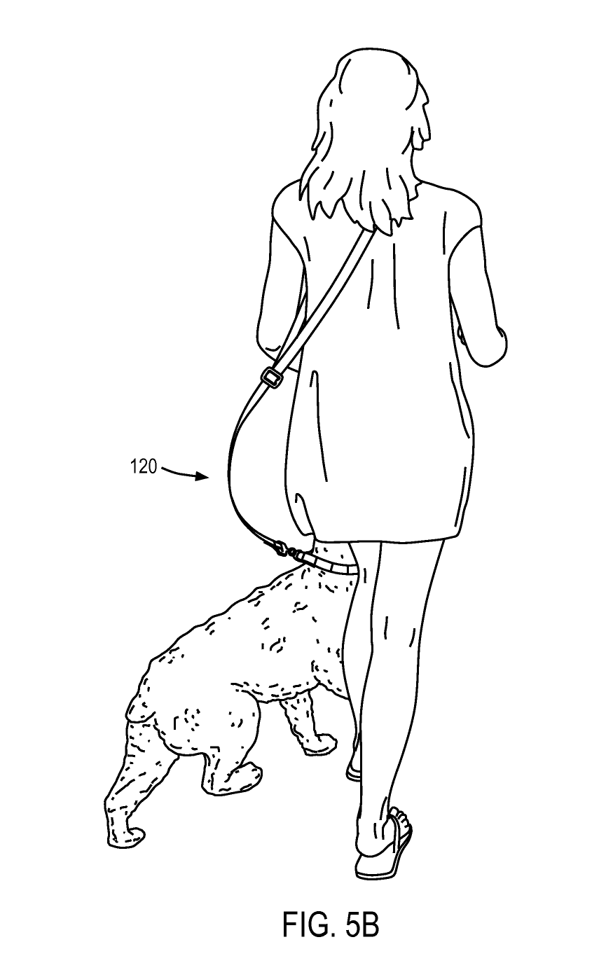

FIGS. 5A-5B are front and back views, respectively, showing a pet owner using the leash collar set 100 configured for sling-carry hands-free mode while running or walking with her dog.

As described above and as shown in FIG. 1B, one advantage of incorporating a triple bar slide 124 in the construction of leash 120 is the formation an adjustable leash strip loop 129 with an adjustable loop circumference. In addition to the uses already discussed above, the ability to form an adjustable loop 129 also increases the flexibility of modes of wearing the leash 120. For example, instead of holding loop 129 with a hand, the loop 129 can be adjusted to be worn in a hands-free manner by securely slinging the leash loop 129 across the chest of the user, in a manner similar to wearing a messenger bag. Other alternative modes of wearing leash 120 may also be possible, such as the wearing of leash 120 around the user's waist.

In sum, advantages of using the above described lightweight weather resistant materials to construct leash strip 122, collar strip 182, and their respectively hardware components for leash collar set 100 include portability, durability, comfort, ease of storage, tangle resistance, corrosion resistance, environmental awareness and longevity.

Many modifications of the leash collar set 100 are possible. For example, for night walks along streets with poor lighting, reflector buckles can be used for illuminating collar 180 from automobile headlights. Many different variations of quick release buckles can also be used including single side release, center release, and cam buckles. It is also possible to incorporate a relatively short length (e.g., approximately two to six inches) of a slightly elastic material, such as bungee or rubber, within leash 120 to function as a shock absorber, while still retaining the controllability and feedback characteristics of an unmodified leash.

While this invention has been described in terms of several embodiments, there are alterations, modifications, permutations, and substitute equivalents, which fall within the scope of this invention. It is therefore intended that the following appended claims be interpreted as including all such alterations, modifications, permutations, and substitute equivalents as fall within the true spirit and scope of the present invention.

What is claimed is:

1. A weather resistant and lightweight leash collar set comprising:
a collar including:
a collar strip having a first end and a second end, wherein the collar strip is constructed by folding at least two layers of a thin and lightweight material;
a buckle having a first mating section and a corresponding second mating section, wherein the first end of the collar strip is coupled to the first mating section, and wherein the collar strip is looped around a bar of the second mating section, enabling the second mating section to slide along the collar strip;
a triple bar collar slide having a first end bar, a middle bar and a second end bar, wherein the middle bar is attached to the second end of the collar strip, and wherein the collar strip is threaded between the first end bar and the middle bar of the collar slide and also threaded between the second end bar and the middle bar of the collar slide, thereby enabling an overall length of the collar to be adjustable; and
a double bar attachment having an outer bar and an inner bar, wherein the collar strip is threaded between the outer bar and the inner bar of the double bar attachment; and
a leash including:
a leash strip having a first end and a second end, wherein the leash strip is constructed by folding at least two layers of a thin and lightweight material;
a latching attachment attached to the first end of the leash strip, and wherein the latching attachment is configured to be secured to the double bar attachment of the collar; and
a triple bar leash slide having a first end bar, a middle bar and a second end bar, and wherein the middle bar is attached to the second end of the leash strip, and wherein the leash strip is threaded between the first end bar and the middle bar of the leash slide and also threaded between the second end bar and the middle bar of the leash slide, thereby forming an adjustable leash strip loop with an adjustable leash loop circumference.

2. The leash collar set of claim 1 wherein the leash strip further includes a user-assessable built-in pocket configured to store a useful item.

3. The leash collar set of claim 2 wherein the built-in pocket includes a buttonhole-type opening through at least one layer of the material for inserting the useful item into the pocket and for removing the useful item from the pocket.

4. The leash collar set of claim 2 wherein the useful item is one of a pet waste baggie, a key, an identification, a medical supply and a pet treat.

5. The leash collar set of claim 1 wherein the adjustable leash strip loop can be configured to be slung securely across a chest of a user, thereby resting on a shoulder of the user.

6. The leash collar set of claim 1 wherein the leash strip and the collar strip are constructed by folding at least four layers of the material.

7. The leash collar set of claim 1 wherein the latching attachment is one of a spring hook, swivel hook, snap hook and carabiner hook.

8. The leash collar set of claim 1 wherein the double bar attachment is one of a a double bar ring and a double bar loop.

9. The leash collar set of claim 1 wherein the buckle is a quick release buckle.

10. The leash collar set of claim 1 wherein the material is a recycled fast-drying ripstop nylon material.

11. The leash collar set of claim 1 wherein the buckle, the collar slide, the double bar attachment, the latching attachment and the leash slide are made from a weather resistant polymer.

12. The leash collar set of claim 1 wherein the leash incorporates a relatively short length of a shock absorbing material.

13. A weather resistant and lightweight leash comprising:
a leash strip having a first end and a second end, wherein the leash strip is constructed by folding at least two layers of a thin and lightweight material;
a latching attachment attached to the first end of the leash strip, and wherein the latching attachment is configured to be secured to at least one of a collar or harness; and
a triple bar leash slide having a first end bar, a middle bar and a second end bar, and wherein the middle bar is attached to the second end of the leash strip, and wherein the leash strip is threaded between the first end bar and the middle bar of the leash slide and also threaded between the second end bar and the middle bar of the leash slide, thereby forming an adjustable leash strip loop with an adjustable leash loop circumference.

14. The leash of claim 13 wherein the leash strip further includes a user-assessable built-in pocket configured to store a useful item.

15. The leash of claim 14 wherein the built-in pocket includes a buttonhole-type opening through at least one layer of the material for inserting the useful item into the pocket and for removing the useful item from the pocket.

16. The leash of claim 13 wherein the adjustable leash strip loop can be configured to be slung securely across a chest of a user, thereby resting on a shoulder of the user.

17. A weather resistant collar comprising:
a collar strip having a first end and a second end, wherein the collar strip is constructed by folding at least two layers of a thin and lightweight material;
a buckle having a first mating section and a corresponding second mating section, wherein the first end of the collar strip is coupled to the first mating section, and wherein the collar strip is looped around a bar of the second mating section, enabling the second mating section to slide along the collar strip;
a triple bar collar slide having a first end bar, a middle bar and a second end bar, wherein the middle bar is attached to the second end of the collar strip, and wherein the collar strip is threaded between the first end bar and the middle bar of the collar slide and also threaded between the second end bar and the middle bar of the collar slide, thereby enabling an overall length of the collar to be adjustable; and
a double bar attachment having an outer bar and an inner bar, wherein the collar strip is threaded between the outer bar and the inner bar of the double bar attachment.

18. The collar of claim 17 wherein the collar strip further includes a user-assessable built-in pocket configured to store a useful item.

19. The collar of claim 18 wherein the built-in pocket includes a buttonhole-type opening through at least one layer of the material for inserting the useful item into the pocket and for removing the useful item from the pocket.
